(19) United States
(12) Patent Application Publication
(10) Pub. No.: US 2013/0068748 A1
(43) Pub. Date: Mar. 21, 2013

(54) METHOD AND APPARATUS FOR PROVIDING HEAT TO A REGION AROUND A HOLE

(71) Applicant: W.E.T. AUTOMOTIVE SYSTEMS, LTD., Windsor (CA)

(72) Inventors: Sergiu Csonti, Windsor (CA); Syed Rafat Iqbal, Windsor (CA); Igor Spasojevic, Belle River (CA); Tim Normand, Lasalle (CA); Jack Barfuss, Windsor (CA); Travis Taylor, Windsor (CA)

(73) Assignee: W.E.T. AUTOMOTIVE SYSTEMS, LTD., Windsor (CA)

(21) Appl. No.: 13/621,890

(22) Filed: Sep. 18, 2012

Related U.S. Application Data
(60) Provisional application No. 61/537,360, filed on Sep. 21, 2011.
(60) Provisional application No. 61/645,297, filed on May 10, 2012.

(51) Int. Cl. H05B 3/02

(52) U.S. Cl. 219/202; 219/209

(57) ABSTRACT

A heater comprising: at least one carrier comprising: a first electrically functional layer disposed on the carrier; a second electrically functional layer disposed on the carrier and in contact with the first electrically functional layer; and one or more electrical conductors connected to the first electrically functional layers for applying power to the heater; wherein the heater includes one or more of the following features: (1) heating around the through holes in the heater (2) variable widths of the electrically functional layers so that the current density in the heating regions is constant; (3) multiple discrete carriers that are electrically connected; and (4) split buss bars that provide an equal current density around the through holes and to the heating regions.

### CLAIM PRIORITY

The present teachings are related to U.S. Provisional Application Ser. No. 61/537,361 filed Sep. 21, 2011, and U.S. Provisional Application Ser. No. 61/645,297 filed May 10, 2012, the contents of which are incorporated by reference herein.

### FIELD

The present teachings generally relate to a heater and more particularly to a vehicle seat heater that provides heat to regions adjacent holes in the heater, multiple discrete carriers, and/or an even current density across a heating region.

### BACKGROUND

Typical, heating devices include a conductive material that provides heat when attached to an energy source. Some heating devices heat by applying power'to a metal wire (i.e. copper wires) that runs throughout the heater. However, more recently heaters have a substrate layer that includes: a positive conductive path and a negative conductive path printed on the substrate with a resistive material printed on the substrate layer between the positive conductive path and the negative conductive path so that when power is supplied heat is produced. Examples of such heating devices are disclosed in U.S. Pat. Nos. 3,287,884; 4,777,351; 4,852:228; 5,432,322; 6,194,692; 6,495,809; 6,884,965; 7,053,344; 7,202,444; 7,284,748; 7,306,283; 7,500,536; and 7,741,582 all of which are express. incorporated herein by reference for all purposes.

In some instances through holes are created that pass through the substrate so that the heater is flexible and is suitable for use in a vehicle seat. However, the introduction of through holes in the substrate has led to heaters that have non-heated zones around cut-outs, through holes, apertures, or a combination thereof; temperature variations along the surface of the heater; reduced heating capacity; or a combination thereof. Furthermore, in systems that include a fan, a blower, or both these colds spots are magnified because of the air flow through the through holes, Additionally, the through holes reduce the space available for the electrically functional layers, which reduces the amount of available heating area, heater efficiency, heater effectiveness, or both. More recently, vehicle seats have begun introduce additional features to increase occupant comfort, such as, variable thigh supports that adjust to the height and/or length of an occupant so that a taller passenger may extend the seat portion to support his or her legs, however, the added seat portion may not be heated and this portion may feel cold to the occupant.

It would be attractive to have a heater that includes increased flexibility while maintaining uniform heating around the through holes, cut-outs, apertures, movable part of a vehicle seat, or a combination thereof. It would further be attractive to have a heater that heats the area directly adjoining a through hole in the carrier. What is needed is a heater that assists in heating air that passes through the through holes in the carrier. It would be attractive to have a heater portion that accommodates movement of the seat so that extended regions of the seat are heated while providing a high durability so that the heater does not fail due to repeated movement. If would further be attractive to configure the electrically functional layers to maximize the heater area while maintaining tolerances for installation, manufacturer requirements, or both.

### SUMMARY

The present teachings surprisingly solve one or more of these need by providing: a heater comprising: at least one carrier comprising: a first electrically functional layer disposed on the carrier; a second electrically functional layer disposed on the carrier and in contact with the first electrically functional layer; and one or more electrical conductors connected to the first electrically functional layers for applying power to the heater; wherein the heater includes one or more of the following features: (1) one or more through holes in the heater, wherein the first electrically function layer includes a portion having a first polarity and a portion having a second polarity that each border a region of at least one of the one or more through holes, and the second electrically functional layer being disposed so that second electrically functional layer electrically connects the portion having the first polarity aced the portion having the second polarity so that the region around the at least one of the one Or more through holes is heated; (2) the first electrically functional layer being a conductive material, wherein the first electrically function layer includes: a primary conductive path having a first width; and, a secondary conductive path having a second width that is reduced relative to the primary conductive path, the secondary conductive path adjoining the primary conductive path so that the width of the secondary conductive path is approximately proportional to current carrying requirement for the or more heating reagions; (3) wherein the at least one carrier is a plurality of discrete carriers, and each discrete carrier includes the first electrically functional layer, and the second electrically functional layer, wherein at least one of the plurality of discrete heaters is connected to one or more electrical conductors that supply power to the heater, and wherein each of the plurality of discrete heaters are electrically connected so that when power is applied each of the discrete carriers produce heat; and (4) one or more through holes in the carrier, wherein the first electrically functional layer has a buss portion having a first polarity and a buss portion having a second polarity, wherein the buss portion having a first polarity, the buss portion having a second polarity, or both split so that one of the buss portion having a first polarity or the buss portion having a second polarity extends simultaneously around at least one of the one or more through holes so that the at least one of the one or more through holes is substantially surrounded by a buss portion having a first polarity or a buss portion having a second polarity

One possible embodiment of the present teachings include: a heater comprising: a carrier, the carrier including: a first electrically functional layer that is made of a conductive material; a second electrically functional layer that is made of a resistive material and is in electrical contact with the first electrically functional layer; one or more electrical conductors connected to the first electrically functional layer for applying power so that heat is created; a one or more through holes in the carrier; wherein the first electrically functional layer includes a portion having a first polarity and a portion having a second polarity; wherein the portion having a first polarity borders a portion of the one or more through holes in the carrier, and the portion having a second polarity borders an opposing portion of the one or more through holes in the carrier so that the portion having a first polarity and the portion having a second polarity are located opposite each other and the one or more through holes are located therebetween; and wherein the second electrically functional layer (i.e., a resistive layer) is located proximate to the one or more through holes in the carrier and electrically connects the portion having a first polarity and the portion having a second polarity so that a region of the carrier located proximate to the one or more through holes (i.e., an area between the one or more through holes in the carrier and the portion having a first polarity and the portion having a second polarity) are heated.

Another unique aspect of the teachings herein is a heater comprising: a plurality of discrete carriers, each discrete carrier including: a first electrically functional layer and a second function layer disposed on each of the discrete carriers so that when power is supplied each of discrete carriers produces heat; wherein at least one of the plurality of discrete heaters is connected to one or more electrical conductors that supply power to the heater; and wherein each of the discrete carriers are electrically connected.

A heater comprising: a carrier having: a one or more through holes; a first electrically functional layer; and a second electrically functional layer; wherein the first electrically functional layer includes: an outer buss structure and an inner buss structure; wherein the outer buss structure extends around a periphery of the carrier and the outer buss structure forms a split and extends around the one or more through holes.

One unique aspect of the present teachings envisions a heated seat comprising: a cushion with one or more trench areas; the heater taught herein; and a trim layer that covers the heater, an occupant sensor mat, a cushion, or a combination thereof.

Another unique aspect of the present teachings envisions a method of heating the region surrounding a through hole comprising: obtaining a carrier that includes at least one through hole in the carrier; applying a first electrically conductive layer around at least a portion of the through hole so that there is a region between the first electrically functional layer and the through hole that is free of the first electrically functional layer; applying a second electrically functional layer around at least a portion of the through hole so that there is a region between the second electrically functional layer and the through hole that is free of the second electrically functional layer, and so that the first electrically functional layer and the second electrically functional layer are tree of contact; applying a resistive layer to the region between the first electrically functional layer and the through hole and the second electrically functional layer and the through hole, and in contact with both the first electrically functional layer and the second electrically functional layer so that at least a portion of the region between the first electrically functional layer and through hole and the second electrically functional layer and the through hole includes the resistive layer; applying power to the first electrically functional layer so that e resistive layer produces heat around the through hole.

The teachings herein surprisingly solve one or more of these problems by providing a heater that includes increased flexibility while maintaining uniform heating around the through holes, cut-outs, apertures, movable part of a vehicle seat, or a combination thereof. The teachings herein provide a heater that heats the area directly adjoining a through hole in the carrier. The teachings provide a heater that assists in heating air that passes through the through holes in the carrier. The teachings provide a heater portion that accommodates movement of the seat so that extended regions of the seat are heated while providing a high durability so that the heater does not fail due to repeated movement. The heater taught herein is configured so that the electrically functional layer maximizes the heater area while maintaining tolerances for installation, manufacturer requirements, or both.

### BRIEF DESCRIPTION OF THE DRAWINGS

FIG. 1 illustrates an example of a heating device of the teachings herein;

FIG. 2 illustrates a close up view of one through hole of FIG. 1;

FIGS. 3A-B illustrate possible cross-sectional views of a heater as discussed herein;

FIG. 4 illustrates a heater as taught herein located on one possible vehicle seat as taught herein;

FIG. 5 illustrates another possible example of a heating device of the teachings herein;

FIG. 6 illustrates a possible example of electrically functional conductive paths of the present teachings;

FIG. 7 illustrates an example of a heating device herein with electrically functional layers around the through holes;

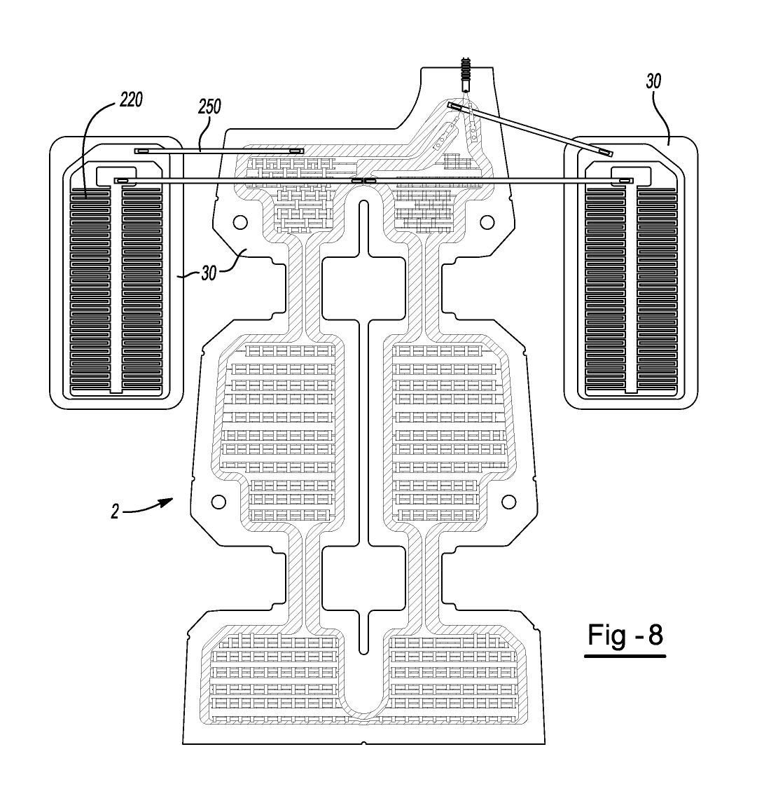

FIG. 6 illustrates an example of heating device with multiple discrete carrier portions joined by one or more jumpers; and

FIG. 9 illustrates a close-up view of a jumper connection with a carrier.

### DETAILED DESCRIPTION

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present teachings are predicated upon providing an improved heating device. The heating device includes at least one carrier. The heating device may be comprised of one or more carriers. Preferably, the heating device may be comprised of a plurality of discrete carriers that are in electrical communication. For example, the heater may include a discrete main carrier portion in electrical communication with one or more discrete secondary carrier portions. The discrete main carrier portion may fit a cushion. Preferably, the heater includes two discrete secondary carrier portions that are juxtaposed with the discrete main carrier portion. The discrete secondary carrier portions may be configured so that the discrete secondary carrier portions may fit a bolster of a seat, extend across a trench, fit a thigh region, connect the cushion and the back, extend across the bite line, or a combination thereof. The discrete main carrier portion and the one or more discrete secondary carrier portions may be in electrical communication using any device that electrically connects, physically connects, or both the discrete main carrier portion to the discrete secondary carrier portion. Preferably, the discrete main carrier portion and the one or more discrete secondary carrier portions may be in electrical communication using a device and/or method that is free of mechanical attachment (e.g., a mechanical fastener). Preferably, the discrete main carrier portion and the discrete secondary carrier portion are connected by at least one jumper.

The jumper may be any device that physically connects, electrically connects, or both the discrete main carrier portion more secondary carrier portions. The jumper may be any device that physically connects and electrically connects the discrete secondary carriers to the discrete main carrier and allows the carriers to move relative to each other without stretching the discrete main carrier, the discrete secondary carrier, the jumper, or a combination thereof. For example, the jumper may enable the discrete secondary portions to move up and down relative to the discrete main carrier and/or the discrete secondary portions without the discrete main carrier portion and/or the discrete secondary portions twisting, stretching, bending out of plane, or a combination thereof. In another example, when the heater is in an uninstalled position the jumper may allow the discrete secondary carriers to hang limp from the discrete main carrier portion. The jumper may be of sufficient size, thickness, width, or a combination thereof so that enough power may be transferred through the jumper to an adjoining carrier and produce heat. The jumper may have a width of about 1 mm or more, about 2 mm or more, or about 3 mm or more, and the first electrically functional layer may have substantially the same width. The jumper may have a width of about 10 mm or less, about 7 mm or less, or about 5 mm or less, and the first electrically functional layer may have substantially the same width.

The one or more jumpers may be made of any material taught herein. Preferably, the jumper may be made of the same material as the carrier. More preferably, the jumper may include a first electrically functional layer on at least one side. Even more preferably, the jumper includes a first electrically functional layer on one side and the first electrically functional layer of the jumper is in electrical communication with the first electrically functional layer of the discrete main carrier portion and the discrete secondary carrier portion so that the jumper electrically connects the discrete main portion with the discrete secondary carrier portion. Most preferably, the jumper is free of the second electrically functional layer. The jumper may include a sufficient amount of the first electrically functional layer so that power may transfer from one discrete carrier to another discrete carrier to produce heat. One or more jumpers may form a connection to the discrete main carrier portion the discrete secondary carrier portions, or both by any device and/or method that provides both a physical connection and an electrical connection, and the connection is free of a mechanical fastener, a fastener that extends though the carrier, a fastener adding additional parts, or a combination thereof. One or more jumper may attach to the discrete main electrically functional carrier, the discrete secondary electrically functional carrier, or both at any location so that the jumper allows power to pass therebetween. Preferably, the jumper is attached to, a buss of the discrete main electrically functional carrier, the discrete secondary electrically functional carrier, or both so that power passes between the discrete carriers. It is contemplated that a single jumper may be used to form the connection between two discrete carriers. For example, a jumper may have an electrically functional layer printed on both sides and one side may be a positive electrically functional layer and the opposing side may have a negative electrically functional layer. One side may be attached directly to each discrete carrier and the opposing side may be attached to the discrete carriers using another second single sided jumper, a connector, an indirect connector, or a combination thereof.

The connection may be formed g ultra sonic welding. Ultrasonic welding may be performed at a low enough temperature so that the carrier is not damaged other than to bond the jumper to the carrier and vice versa. Ultrasonic welding may be performed without the addition of an external heat source (i.e. the only heat created is from the pressure and vibration of the ultrasonic welder). Thus, the base material may be heated (i.e. warmed), but not to a high enough temperature that the physical properties of the carrier are changed (e.g. melted, warped, damaged, or the like) at a location other than the point of contact. Ultrasonic welding may be directed to a precise location so that the carrier is not damaged and only the jumper and the first electrically functional layer, second electrically functional layer, or both are welded (i.e. melted, fused, bonded, or the like). The depth of the weld may be controlled by adjusting the amount of pressure applied to the jumper and the carrier by the nest (i.e. anvil) and the sonotrode (i.e. horn). A pressure from about 6,000 N/m2 to about 350,000 N/m2 may be applied. Preferably, a pressure from about 13,000 N/m2 to about 170,000 N/m2 may be applied. More preferably, a pressure from about 20,000 N/m2 to about 35,000 N/m2 may be applied. The sonotrode may be used in a normal relationship (i.e. perpendicular) with the nest. The sonotrode may be used in a substantially parallel relationship with the nest. The relationship of the sonotrode and the nest may control the direction of the ultrasonic oscillation and the depth of the weld. For example, when the sonotrode and anvil may be generally parallel to each other the ultrasonic oscillations will be along the same plane (i.e. a vertical oscillation). In another example, when the sonotrode and anvil are normal in relation to each other and the ultrasonic oscillations may be parallel with the sonotrode and perpendicular to the nest (i.e. horizontal oscillation).

The depth of the weld may also be controlled by adjusting frequency. A frequency between about 5 kHz to about 150 kHz may be used to attach the electrical conductor to the carrier. Preferably, a frequency between about 15 kHz to about 70 kHz may be used to attach the electrical conductor to the carrier. More preferably, a frequency between about 20 kHz to about 40 kHz may be used to attach the electrical conductor to the carrier. Preferably, when ultrasonic welding is used the first electrically functional layer, the carrier, and the jumper are transformed so that the carrier and/or the jumper melt together only at the point of contact intertwining the first electrically functional layers so that an electrical connection is formed between the two. The heater may be ultrasonically welded to a bag for use with the conditioning system discussed herein or the walls, the bag may be ultrasonically welded together, or may be used to ultrasonically weld the heater to another article of manufacture. This may be achieved by using the techniques described herein to adjust the depth, heat, frequency, pressure, or a combination thereof to bond the heater to the bag, article of manufacture, a jumper, or a combination thereof. The jumper may be attached via a combination of devices and methods that do not require a mechanical fastener.

The jumper may be connected via a conductive glue, a conductive adhesive, a conductive bonding agent, the like, or a combination thereof (hereinafter referred to as conductive glue). The conductive glue may be any glue that bonds two materials together and assists in forming an electrically conductive connection therebetween. The conductive glue may bond dissimilar materials together. For example, the conductive glue may bond a conductive material (e.g., copper or silver) to a polymeric material (e.g., Mylar, polyester, Melinex). In another example, the conductive glue may bond to dissimilar polymeric materials together in addition to bonding a conductive material to each of the dissimilar polymeric materials. The conductive glue when cured may have a shear strength of about 0.5 MPa or more, about 1.0 MPa or more, or about 1.5 MPa or more when measured using ASTM D 732. The conductive glue when cured may have a shear strength of about 10 MPa or less, about 8 MPa or less about 5 MPa or less, or about 3 MPa or less when measured using ASTM D732.

The conductive glue may be any glue that when cured retains some flexibility so that the glue does not crack and break when subjected to a repeated flexing action. The conductive glue when cured may have a flexural strength of about 10 MPa or more, about 14 MPa or more, or about 17 MPa or more when measured using ASTM D 790. The conductive glue when cured may have a flexural strength of about 40 MPa or less, about 30 MPa or less, about 20 MPa or less, or about 18 MPa or less when measured using ASTM D 790.

The conductive glue may have some elasticity when cured so that the glue may conform to irregular shaped surfaces. The conductive glue when cured may elongate. The cured conductive glue may elongate by about 10 percent or more, about 20 percent or more, or about 25 percent or more when measured using ASTM D 638. The cured conductive glue may elongate by about 100 percent or less, about 80 percent or less, or about 60 percent or less when measured using ASTM D 638. The conductive glue has a tensile strength when cured of about 1 MPa or more, about 3 MPa or more, about 6 MPa or more, or about 8.5 Mpa or more measured using ASTM D 638. The conductive glue has a tensile strength when cured of about 20 MPa or less, about 15 MPa or less, or about 10 MPa or less measured using ASTM D 638.

Preferably, the conductive glue when cored is not brittle. The cured conductive glue may have a hardness of about 20A or higher, about 40A or higher, or about 60A or higher measured using a Shore A durometer. The cured conductive glue may have a hardness of about 100D or less, about 90D or less, about 80D or less, or preferably about 75D or less measured using a Shore durometer (i.e.. between about 70D and about 75D). The conductive glue may cure at room temperature so that the carrier is not subjected to heating and/or damaged to cure the conductive glue. The conductive glue may assist in forming an electrical contact between two opposing electrically conductive layers. The conductive glue may assist in resisting corrosion from forming on the electrically functional layers. The conductive glue may enhance the electrical conduction of the electrically functional layers.

The conductive glue has a conductivity. The conductive glue may have a sufficient conductivity so that the glue assists in forming an electrically connection between two surfaces and bonds the surfaces to together. The conductive glue may be sufficiently conductive so that the conductive glue has a low volume resistivity and is useful in promoting an electrical connection between two opposing surfaces. The conductive glue may have a volume resistivity of about 1.0 Ω*m or more, about 1.0×10⁻¹ Ω*m or more preferably about 1.0×10⁻² Ω*m or more, more preferably about 1.0×10⁻³ Ω*m or more, or even more preferably about 1.0×10⁻⁴ Ω*m or more when measured using method 5011.5 in MIL-STD-883H (i.e. between about 1.74×10⁻⁴ Ω*m and about 2.5×10⁻⁴ Ω*m). The conductive glue may have a volume resistivity of about 1.0×10⁻⁵ Ω*m or less, about 1.0×10⁻⁷ Ω*m or less, about 1.0×10⁻⁶ Ω*m or less, or about 1.0×10⁻⁵ Ω*m or less when measured using method 5011.5 in MIL-STD-883H.

The conductive glue may include a conductive additive. The conductive additive may be any additive that assists in forming an electrical connection. The conductive additive may be any conductive material discussed herein. Preferably, the conductive additive is copper, silver, nickel, gold, or a combination thereof. The conductive additive may be added in a sufficient amount so that an electrical connection may be formed between two opposing surfaces. The conductive additive may be added in a sufficient amount so that the conductive additive assists in forming an electrical connection. The conductive glue may comprise about 10 percent by weight or more, about 20 percent by weight or more, preferably about 30 percent by weight or more, more preferably about 40 percent by weight or more, or even more preferably about 45 percent by weight or more conductive additive (i.e., between about 45 percent and 50 percent by weight conductive additive). The conductive glue may comprise about 90 percent by weight or less, about 75 percent by weight or less, about 60 percent by weight or less, or about 45 percent by weight or less conductive additive. Some examples of conductive glues that may be used are Ekecikut 414 commercially available from Panacol; Eccobond CA 3556HF available from Hysol; and 8331 available from MG Chemicals, all of which are incorporated by reference herein for all purposes.

The heater includes a carrier, a first electrically functional layer, and a second electrically functional layer. The carrier may be made of any material so that a first electrically functional layer, a second electrically function layer, or both can be printed on the carrier. The carrier may be made of any material that is suitable as a heater. The carrier may be insulative. The carrier may be fire resistant. For example, the carrier may withstand temperatures of 50° C. or more, about 75° C. or more, about 100° C. or more, or even about 125° C. or more without the carrier melting, igniting, smoking, or a combination thereof. The carrier may be made of a polymeric material (e.g., thermoset or thermoplastic), and more specifically a thermoplastic polymeric material. The polymeric material may be selected from homopolymers, copolymers, composites, or other material combinations that include one or more of a polyester, a polyimide, polyolefin (e.g., polypropylene, polyethylene, or combination thereof), or polyetherimide. Examples of commercially available materials include one or more of Myfar®, Melinex®, Tyvek®, Cetus®, or UItem®. The carrier may be made of any material as taught herein including the teachings of U.S. patent application Ser. No. 13/106,140 filed on May 12, 2011, Paragraph No. 0042 the teachings of which are incorporated by reference herein.

The carrier includes a periphery. The periphery comprises a top edge, a bottom edge, a first side edge, and a second side edge. The carrier may include one or more of the following: slits, cuts, through holes, cutouts, tabs, features, or a combination thereof. Preferably, the cutouts are located on a periphery of the carrier. The slits, cuts, through holes, cutouts, tabs, features, or a combination thereof may be located at any location on the carrier. The slits, cuts, through holes, cutouts, tabs, features, or a combination thereof may be of any shape and size so that they provide stress relief to the carrier. Additional teachings regarding the slits, cuts, through holes, cutouts, tabs, and features are described in the teachings herein including the teachings of U.S. patent application Ser. No. 13/106,140 filed on May 12, 2011, Paragraph No. 0096, 0099, 0100, 0103, 0112, and 0113 the teachings of which are incorporated by reference herein. The through holes may be any absence of material in a face (i.e. portion of the carrier with the largest surface area) of the carrier. For example, the face of the heater is the portions of the heater that is located on the seat, under the occupant, is in contact with an occupant sensor, in contact with the trim layer, or a combination thereof. The through holes may be the region where material was removed from the carrier. An internal slit may be considered a through hole. An external slit and/or cutout are not a through hole. The through holes may be of any size and shape in the carrier so that the through holes provide stress relief to the carrier so that the carrier bends and resists stretching due to sitting, knee loading, indenting, bags, boxes, heavy objections, or a combination thereof. For example, the through holes may be round, oval, square, cross-like, “T” shaped, “S” shaped, diamond, or a combination of different shaped holes. The carrier may include one through hole. The carrier may include a plurality of through holes, The carrier may include 2, 3, 4, 5, 6, 7, 8, 9, 10, 12, 15, 18, or even 20 through holes in the carrier. The carrier may include about 5 through holes or more, about 8 through holes or more, about 15 through holes or more, or about 20 through holes or more. The carrier may include about 50 through holes or less, about 40 through holes or less, or about 30 through holes or less. Preferably, the carrier includes between about 10 and about 30 through holes in the carrier. The through holes may be all the same size and shape. Preferably, the through holes vary in size, shape, or both. The through holes may be symmetrically located in the carrier. For example, the through holes may be symmetrically located on opposite sides of a centerline of the carrier in a matched fashion. The through holes may be asymmetrically located in the carrier (i.e. located on opposite sides of a centerline in an unmatched fashion).

The carrier includes two electrically functional layers. Preferably, the first electrically functional layer is made of a conductive material and the second electrically functional layer is made of a resistive material. The electrically functional layers may be applied by any known method taught herein including those of Paragraph No. 0046 of U.S. patent application Ser. No. 13/106,140 filed on May 12, 2011, the teachings of which are incorporated by reference herein. Preferably, the electrically conductive layers are applied by screen printing or using a printer (e.g. an inkjet printer, bubble jet, laser, piezo, the like, or a combination thereof). A piezo print head that may be used is any piezo print head capable of printing high viscosity inks such as the inks disclosed herein. The electrically functional layers may be any shape and thickness so that the electrically functional layers conduct electricity and produce heat. The electrically functional layers may have a thickness as taught herein including a thickness of Paragraph No. 0046 of U.S. patent application Ser. No. 13/106,140 filed on May 12, 2011, the teachings of which are incorporated by reference herein.

The first electrically functional layer is conductive (i.e. a conductive electrically functional layer). The conductive electrically functional layer may be made of any material or combination of materials that conducts electricity. The conductive electrically layer may be made of a nanoink. The conductive electrically layer may be made of copper. Preferably, the conductive electrically functional layer may be made of silver or nano-silvery. The conductive electrically functional layer may be made of any material taught herein and/or any material including the material characteristics as taught herein including those of Paragraph Nos. 0050 to 0061, of U.S. patent application Ser. No. 13/106,140 filed on May 12, 2011, the teachings of which are incorporated by reference herein. Examples of commercially available copper inks that may be used are CB200 copper conductor and CB230 Copper Conductor available from DuPont. An example of a commercially available silver ink that may be used is a family of 5000 series from DuPont. More particularly, a 5064H silver ink available from DuPont.

The second electrically functional layer is a resistive layer (i.e., a resistive electrically functional layer). The resistive layer may be any material that when electricity is passed through the material the material produces heat. Preferably, the material will exhibit positive temperature coefficient characteristics. It may be made of a co-polymer binder mixed with carbon particles (e.g. natural carbon, petroleum carbon, carbon flakes, graphite, or the like), additives (e.g. anti-foaming, anti-froth, adhesive, fire retardant, or the like), fillers (e.g., clay, titanium dioxide, or the like), solvents (e.g. alcohol based, ethanol based, or the like), or a combination thereof. Additional aspects of the electrically functional resistive layer such as material characteristics can be gleaned from the teachings herein including those of paragraphs 0014, 0016, 0050, 0061, 0062, and 0090, of U.S. patent application Ser. No. 13/106,140 filed on May 12, 2011, the teachings of which are incorporated by reference herein. Preferably, the resistive electrically functional layer may be made of PTC ink, for example, DuPont 7262 family of inks.

The electrically functional layers may be applied to the carrier in virtually any pattern. The first electrically functional layer includes at least a positive electrically functional layer portion and a negative electrically functional layer portion. Preferably, the first electrically functional layer is applied to the carrier so that the carrier includes a positive conductive electrically functional layer and a negative electrically functional layer. The positive and negative electrically functional layers each include at least one electrode and an interdigitated portion (i.e., fingers). The positive electrically functional layers and the negative electrically functional layers may include one or more electrically functional paths. The electrically functional paths may be of any shape, size, configuration, or a combination thereof so that when a second electrically functional layer is applied to the first electrically functional layer heat is produced. Preferably, the size, shape, configuration, or a combination thereof of the first electrically functional layer is such that power distribution throughout the heater is substantially constant over an area of the heater so that when a second electrically functional layer is applied to the first electrically function layer, heating over an area of the heater is substantially equal. More preferably, the size, shape, configuration, or a combination thereof of the first electrically functional layer is such that power distribution and heating are substantially equal in a region adjacent to a through hole in a heater and heat is produced proximate to the edge of the heater (i.e., heat is produced within about 1.0 mm or less, about 0.5 mm or less, or even about 0.1 mm or less of the edge of the through hole).

The electrically functional layers include one or more main electrically functional path (i.e., a buss bar, an electrode, or both). Preferably, the electrically functional layers include at least two main electrically functional paths. One or more of the main electrically functional paths may split along its length. Preferably, one or more of the main electrically functional paths may split along the length and substantially surrounded an aperture, void, through hole, feature, or a combination thereof. More preferably, the split substantially surrounds and/or surrounds an aperture, void, through hole, feature, or a combination thereof that allow air to move though the carrier as discussed herein. The split in the main electrically functional layer may include one or more apertures, voids, through holes, features, or a combination thereof between the two or more portions of the main electrically functional layers. The one or more main electrically functional paths may include splits in series. For example, the splits in series may occur along the length of the main electrically functional layers. The one or more main electrically functional paths may include about 1 split or more, about 2 splits or more, about 3 splits or more, about 4 splits or more, about 6 splits or more, or even about 8 splits or more splits in series. The one or more main electrically functional paths may include about 20 splits or less, about 15 splits or less, or about 12 splits or less splits in series. Preferably the one or more main electrically functional paths include between about 4 splits and 10 splits in series. For example, the main electrically functional layer may split 4 times so that at least 4 through holes in the carrier are substantially surrounded. The main electrically functional paths may surround and/or substantially surround about one or more 2 or more, 3 or more or even 4 or more voids, apertures, through holes, features, or a combination thereof at the same time. The main electrically functional paths may surround and/or substantially surround about 10 or less, about 8 or less, or about 6 or less voids, apertures, through holes, features, or a combination thereof at the same time. The main electrically functional paths may include splits in parallel. For example, the main electrically functional path may split into three portions so that two adjacent through holes are separated by a split buss passing there between with a buss passing around the outside of each respective through hole.

The main electrically functional path may have two splits in parallel or more, three splits in parallel or more, or even 4 splits in parallel or more. The splits in parallel in the main electrically functional paths include an aggregate width. Preferably, an aggregate width of the in parallel splits in the main electrically functional paths remains substantially constant to that of the non-split portions of the main electrically functional paths. For example, the combined width of the two or more in parallel splits in the main electrically functional path are equal to or less than the width of the main electrically functional path before the split, after the split, or both. More preferably, the width of the main electrically functional paths gradually narrows as the main electrically function path becomes further from the power source, and any in parallel splits in the main electrically functional paths have an aggregate width substantially equal to the width prior to the split, after the split, or both, The aggregate in parallel width of the main electrically functional paths may be less than the width prior to the split, after the split, or both. The aggregate in parallel width of the main electrically functional paths may be any width so that a sufficient amount of power may be: supplied to the heating region, supplied if one electrically functional path becomes damaged, or both. The current carrying capacity of the aggregate width of a main electrically functional layer may be substantially equal to a single width of a main electrically functional layer, to the main electrically functional layer before the split, the main electrically functional layer after the split, or a combination thereof. The amount of power passing through the aggregate width of the split in the main electrically functional path is substantially equal to the amount of power passing through the main electrically functional path before and after the split. The amount of power supplied to the heating regions may be the same before the split, after the split, and during the split so that the amount of power at the heating regions remains constant. The in parallel width of the electrically functional paths may be any width so that the electrically functional path maximizes the heating area; the electrically functional path may fit between and a void, through hole, aperture, feature, or a combination thereof and an edge of the carrier (e.g., an internal slit, an external slit, cutout, through hole, feature, a peripheral edge era combination thereof); or both so that the number of conductive paths may be maximized in the heating regions so that the heater heats,

The main electrically functional paths may be located in a high stress, region (e.g., under an occupant); proximate to a void, aperture, through hole, feature, or a combination thereof that creates a high stress region; or both. The splits in the main electrically functional paths may provide an electrical path in the event of a failure of one of one split in the main electrically functional path so that power continues to extend through the main electrically functional paths. The main electrically functional path may be spaced a distance from an outer edge of the carrier (i.e., the outer periphery of the carrier). The distance may be any distance so that the current flow through main electrically functional paths does not interfere with surrounding components (e.g., occupant sensor, air mover, or both). The distance may be any distance so that the main electrically functional path may pass between an edge of the carrier and an edge of a void, aperture, through hole, feature, or a combination hereof. The main electrically functional paths may have an average distance from the edge of about 1 mm or more, about 2 mm or more, or about 3 mm or more. The main electrically functional path may have an average distance from the edge of about 10 mm or less, about 8 mm or less, or about 6 mm or less.

The electrically functional paths may include one or more conductive paths that are connected directly an for indirectly to the main electrically functional paths. For example, the electrically functional layers may include a primary electrically conductive path, a secondary electrically conductive path, a tertiary electrically conductive path, etc . . . , or a combination thereof, and the primary electrically functional path connects directly to the main electrically functional path on one side/end and the secondary electrically conductive path on an opposing side and/or end. The tertiary electrically functional path may connect to a side and/or end of the secondary electrically functional path that opposes the primary electrically functional path and so on as more paths are included. The electrically functional layers may include one or more widths. The width of the electrically functional paths may remain constant as the paths travel away from the main electrically functional paths. The width of the electrically functional paths may become smaller as the electrically functional paths travel away from the main electrically functional path. The width of the electrically functional paths may step down incrementally as the electrically functional paths travel away from the main electrically functional path. For example, a primary electrically functional path may have a first width, a second electrically functional path may have a second width, and the third electrically functional path may have a third width.

The primary electrically functional path may have a width X. The secondary electrically functional path may have a width of between about 1.0X and about 0.7X and preferably between about 1.0X and about 0.8X. The tertiary electrically functional path may have a width of between about 0.8X and about 0.3 X, preferably between about 0.7X and about 0.4X (i.e., between but 0.65X and about 0.45X). The primary electrically functional path may have a width of about 3.0 mm or less, about 2.5 mm or less, or about 2.2 mm or less. The primary electrically functional path may have a width of about 1.0 mm or more, about 1.2 mm or more, or about 1.4 mm or more. Preferably, the primary electrically functional path may have a width of between about 3.0 mm and about 1.2 mm, and more preferably between about 2.5 mm and about 1.4 mm (i.e., about 2.0 mm). The secondary electrically functional path may have a width of about 3.0 mm or less, about 2.5 mm or less, or about 2.2 mm or less. The secondary electrically functional path may have a width of about 0.8 mm or more, about 1.0 mm or more, or about 1.1 mm or more. Preferably the secondary electrically functional path may have a width of between about 2.5 mm and about 0.8 mm, and more preferably between about 2.2 mm and about 1.3 mm (i.e., about 2.0 mm). The tertiary electrically functional path may have a width of about 1.5 mm or less, about 1.2 mm or less, or about 1.1 mm or less. The tertiary electrically functional path may have a width between about 0.5 mm or more, about 0.7 mm or more, or about 0.9 mm or more. Preferably, the tertiary electrically functional path has a width of between about 1.4 mm and about 0.8 mm, and more preferably between about 1.2 mm and about 0.9 mm (i.e., about 1.0 mm). The primary electrically function path, the secondary electrically functional path, the tertiary electrically functional path, or a combination thereof may have a width that varies along the length of each respective path. For example, a path may begin with a width of about 2.0 mm and end with a width of about 1.8 mm.

The width of the primary electrically function path, the secondary electrically functional path, the tertiary electrically functional path, or a combination thereof may vary by about 10 percent or more, about 20 percent or more about 30 percent or more along the length of the respective path. The width of the primary electrically function path, the secondary electrically functional path, the tertiary electrically functional path, or a combination thereof may vary by about 100 percent or less, about 80 percent or less, or about 60 percent or less along the length of the respective path. The width of the primary electrically function path, the secondary electrically functional path, the tertiary electrically functional path, or a combination thereof may be varied so that the current density supplied to the heating regions remains substantially constant along the length of each respective path. For example, the amount of power per millimeter of width of each respective path may have relatively (e.g., the current is within about 20 percent or less, preferably within about 15 percent or less, or more preferably within about 10 percent or less when measured along the length) the same amount of power along the length of each respective path so that the current density remains substantially constant along the length of the electrically functional layer. The current carrying capacity of the primary electrically function path, the secondary electrically functional path, the tertiary electrically functional path, or a combination thereof may be substantially proportional to the width of each respective path. For example, a path with a width of 10 mm may have a current carrying capacity of about 1 Amp and a path with a width of about 5 mm may have a current carrying capacity of about 0.5 Amps. The current carrying capacity of each conductive path may be varied based upon the width of each path, the current required to heat a given heating region to a specific temperature, or both and the width of the path may be substantially proportional to the amount of current required for a given heating region so that the required current may be delivered to the heating region. As discussed herein substantially proportional means that as the width and/or area vary with the current required, the width and/or area are within about 30 percent or less, preferably about 20 percent or less, more preferably about 10 percent or less the current carrying requirements, current carrying capacity, or both. For example, if a given path is 20 mm long and 4 mm wide and the current carrying capacity and the current being applied at the beginning of the path is 1 Amp and the current being applied at the end of the 20 mm is 0.9 Amps, the current carrying requirements remain substantial proportional along the length of the path (i.e., the currents are within about 10 percent of each other). Stated another way as the path becomes further from the power source the amount of available power reduces and the width of the respective path is reduced by a proportional amount so that the heating region area is maximized, the path widths remain as small as necessary to achieve a heating target, or both.

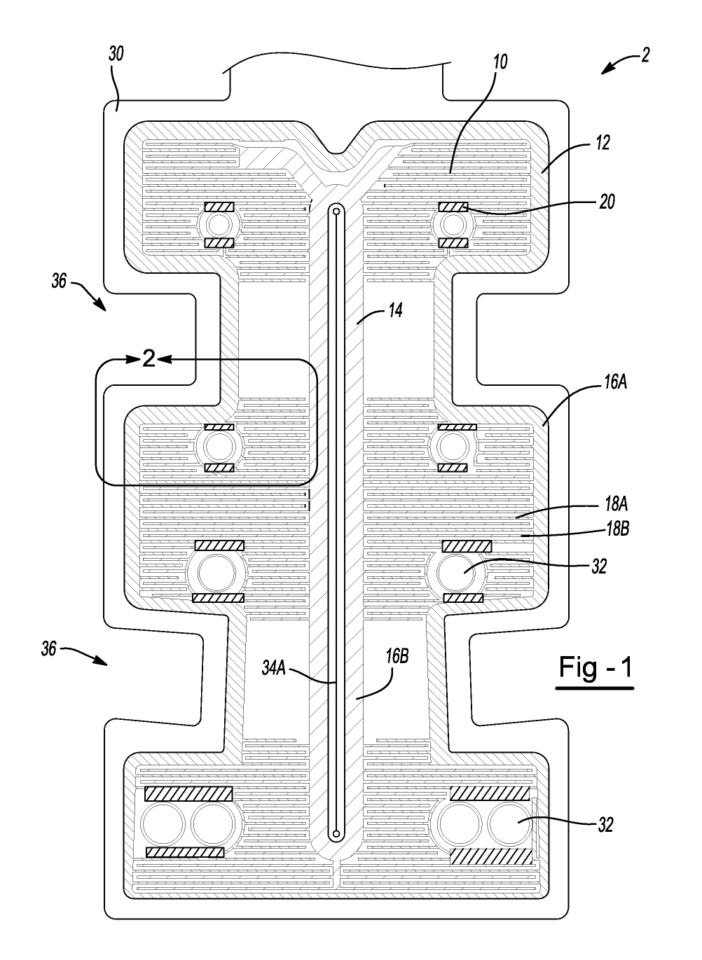

The electrically functional portions alternating fingers or interdigitated portion) are at least partially covered by a second electrically functional layer so that when voltage is applied to the first electrically functional layer electrons pass through the resistive layer and produce heat. The fingers may include a primary electrically functional path, a second electrically functional path, a tertiary electrically functional path, the like, or a combination thereof. Preferably, the fingers are a combination of positive electrically functional paths and negative electrically functional paths that are substantially interdigitated (i.e., form an alternating pattern so that heat may be created). The first and second electrically functional layers may have any shape, pattern, arrangement, or a combination thereof relative to each other. The first electrically functional layer may be generally straight lines. The first electrically functional layer may include curves. The first electrically functional layer may include portions that transverse adjacent to through holes and/or apertures that are formed in the carrier so that the holes and/or apertures may be heated. Additional aspects of the patterns of the electrically functional layers can be gleaned from the teachings herein including those of Paragraph Nos. 0011, 0014, 0015, 0061, and 0102 and FIGS. 1-13 of U.S. patent application Ser. No. 13/106,140 filed on May 12, 2011, the teachings of which are incorporated by reference herein. The first electrically functional layer and the second electrically functional layer generally border a through hole.

The through holes may be heated or unheated. The unheated through holes may not include a positive electrically functional layer, a negative electrically functional layer, a resistive electrically functional layer, or a combination thereof. The unheated through holes may be free of the positive conductive layer, the negative conductive layer, or the resistive layer.

The heated through holes include at least a conductive electrically functional layer and a resistive electrically functional layer. The electrically conductive layers may border the through holes. The conductive electrically functional layer includes a positive electrically functional layer portion and a negative electrically functional layer portion. For example, an electrically conductive layer of a first polarity may substantially border one side of the through hole, and an electrically conductive layer of a second different polarity may substantially border the opposing side of the through hole so that the through hole is located between the electrically functional layers having a first polarity and a second polarity. In combination, the two conductive electrically functional layers do not completely surround the through holes. For example, the two conductive electrically functional layers do not touch each other and form a layer 100% of the way around the through hole (i.e. completing the circuit). The two conductive electrically functional layers may each border about 10 percent or more, about 20 percent or more, preferably about 30 percent or more, more preferably about 45 percent or more, or even more preferably about 47 percent or more of the through hole. The two conductive electrically functional layers each border less than about 50 percent of each through hole, and preferably about 48 percent or less of each through holey The positive and negative conductive electrically functional layers may border different amounts of the through holes. For example, the positive conductive electrically functional layer may border about 20 percent of a through hole and the negative conductive electrically functional layer may border about 75 percent of the same through hole or vice versa. Thus, the two conductive electrically functional layers in combination generally border each through hole so that less than 100 percent of its border is surrounded, preferably about 99 percent or less is surrounded, and more preferably about 95 percent or less is surrounded. The total amount of the two conductive electrically functional layers when added together total less than 100 percent, preferably about 99 percent or less, more preferably about 95 percent or less. The total amount of the two conductive electrically functional layers when added together total about 50 percent or more, about 60 percent or more, about 70 percent or more, preferably about 80 percent or more, or more preferably about 85 percent or more of the border of each through hole.

The electrically functional layer having a first polarity, second polarity, or both may border about 10 percent or more, about percent or more, about 30 percent or more, about 40 percent or more, about 50 percent or more, about 60 percent or more, about 70 percent or more, about 80 percent or more or even about 85 percent or more of each through hole. The percentage of each through hole that is bordered by the conductive electrically functional layer may vary from through hole to through hole. For example, one through hole may be include the conductive electrically functional layer around 20 percent of its border and an adjacent through hole may include the conductive electrically functional layer around 70 percent of its border. The conductive electrically functional layer with a first polarity and the conductive electrically functional layer with a second polarity in combination with the resistive electrically functional layer may substantially surround the through hole.

Preferably, the combination of the conductive electrically functional layer and the resistive electrically function layer surrounds 100 percent of the through hole. More preferably, the conductive electrically conductive layers (i.e. conductive layers of opposite polarity) are connected via the second electrically functional layer (i.e. resistive layer) electrically so that heat is produced in a region proximate to a through hole in the carrier. In this configuration electricity and/or current flows at least partly around the through hole via the second electrically functional layer so that heat is produced. The heater may include a third layer that covers the first electrically functional layer, the second electrically functional layer, or both.

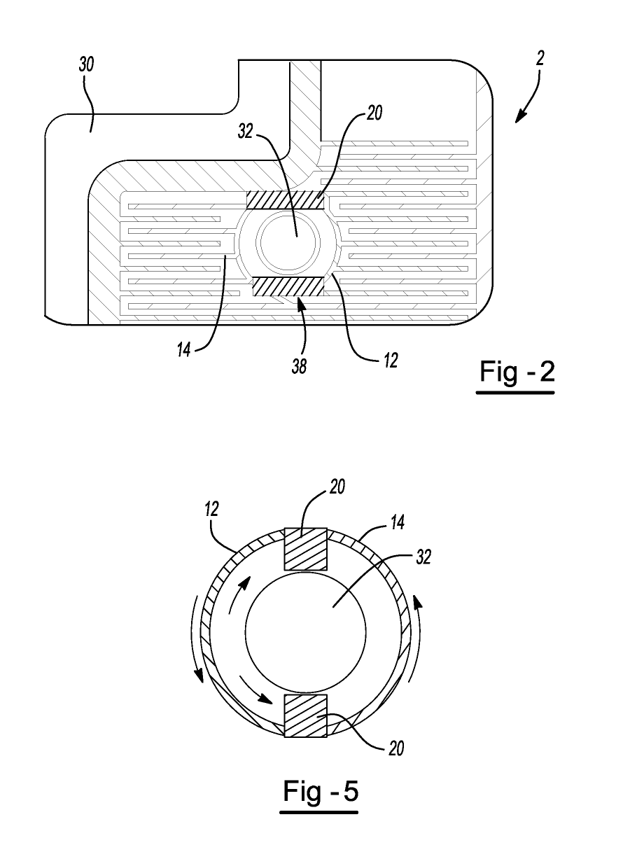

The third layer may be a protective layer. The third layer may'cover all or a portion of the heater. The heater may be free of a third layer. The third layer may have adhesive on both sides so that the third layer may be used to dispose and/or attach adjacent layers to the heater. The third layer may have adhesive on only one side. Preferably, the third layer has adhesive on at least one side. The third layer may protect the first electrically functional layer and the second electrically functional layer from environmental conditions (e.g. dirt, liquids, or other common items found in a vehicle). Preferably, the protective third layer may be selected to resist moisture and humidity. Thus, the third layer may be moisture impermeable. The protective third layer may also conform well to curved surfaces so that the curved surfaces can be protected. The third layer may be a film, a foil, a textile, a coating, a sheet, or any combination. The third layer may be at least partially transparent, it may be at least partially opaque, it may be completely opaque or a combination thereof. The third layer may be made of a polymeric film (e.g. polyester or polyurethane) that may be coated or uncoated on one side or both sides with an acrylic adhesive. The third layer may be glued, laminated, taped (i.e. heat laminated) unto the carrier. One preferable third, layer may be made of ARClad 8350, produced by Adhesive Research. Additional aspects of the teachings regarding the third layer can be gleaned from the teachings herein including those of paragraphs 0064, 0065, 0066, 0067, 0081, 0096, 00114, 00116, and 00117 and FIGS. 2A-2B of U.S. patent application Ser. No. 13/106,140 filed on May 12, 2011, the teachings of which are incorporated by reference herein.

The heater may include a fourth layer. The fourth layer may be an adhesive film. The fourth layer may be used to adhere one of the other layers to the carrier. The fourth layer may be used to adhere the carrier to a seat. The fourth layer may be an adhesive layer (e.g. a glue, paste, spray on adhesive, an adhesive film, a peel and stick, hook and loop, or the like). Preferably, the fourth layer may be a peel and stick film. The heater may be free of a fourth layer. The fourth layer may cover all or a portion of the carrier. Additional aspects of the teachings regarding the fourth layer can be gleaned from the teachings herein including those of paragraphs 0064, 0065, 0066, 0067, 0081, 0096, 00114, and 00116 and FIGS. 2A-2B of U.S. patent application Ser. No. 13/106,140 filed on May 12, 2011, the teachings of which are incorporated by reference herein.

The heater may include a fifth layer. The fifth layer may be a protective layer. The fifth layer may be on a top side of the carrier. The fifth layer may on a bottom side of the carrier. The fifth layer may be made of a woven or unwoven material such as polyester, fleece, polypropylene, rayon, nylon, wool, linen, cotton, any combination thereof, or the like. The fifth layer may be breathable or non-breathable. The fifth layer may include through holes that correspond to the through holes in the heater. Preferably, the fifth layer is a breathable polyester. The size, shape, and configuration of the fifth layer may substantially mirror the size, shape, and configuration of the heater. The fifth layer may be on both sides of the carrier. The fifth layer may be held on the carrier by the fourth layer. Preferably, the fifth layer is disposed and/or attached over the printed side of the carrier. The fifth layer may have a bulk density that is about 0.6 g/cm³ or less, about 0.4 g/cm³ or less, about 0.2 g/cm³ or less, or even about 0.10 g/cm³ or less (i.e. about 0.15 g/cm³ to about 0.04 g/cm³). The heater may be free of a fifth layer. The fifth layer may attach to one or more of the jumpers. The fifth layer may attach to each discrete carrier and be free of attachment to the jumpers. The fifth layer may attach all of the discrete carriers and jumpers together so forming one large piece connected by the fifth layer. The fifth layer may be attached to the jumpers, the carriers, the discrete carriers, or a combination thereof via the third layer, the fourth layer, a separate adhesive, a separate tape, a separate bonding agent, or a combination thereof. The fifth layer may attach the discrete carriers together so that if the discrete carriers are pulled in opposing directions substantially of the stress will be applied to the fifth layer so that the jumper connections will remain intact. Additional aspects of the teachings regarding the fifth layer can be gleaned from the teachings herein including those of paragraphs 0064, 0065, 0066, 0067, 0081, 0096, 00114, and 00116 and FIGS. 2A-2B of U.S. patent application Ser. No. 13/106 140 filed on May 12, 2011, the teachings of which are incorporated by reference herein.

The heater includes an electrical conductor attached to each polarity of the first electrically functional layer. The electrical conductor may be copper wires, silver wires, leads, traces, or a combination thereof. The electrical conductor may be connected to the heater by a mechanical fastener. The electrical conductor may be attached to the carrier using low pressure molding. The electrical conductor may be connected to the heater by welding, soldering, conductive glue, or a combination thereof. Preferably, the electrical conductor is attached to the heater via a mechanical faster that grips the electrical conductor and is attached to the carrier via holes in the carrier. Additional aspects of the attachment techniques for attaching electrical conductors to the carrier can be gleaned from the teachings herein including those of paragraphs 0070, 0077, 0081, and 00124 May 12, 2011, the teachings of which are incorporated by reference herein.

The present teachings are predicated upon providing an improved heater suitable for integration into a variety of articles of manufacture. For example, the heater may be integrated into or attached to carriers (e.g., members, structures, panels, floors, walls, or the like) of various articles of manufacture such as buildings, furniture, transportation vehicles, (e.g., boats, trains, airplanes, motorcycles, all-terrain vehicles, busses, snowmobiles, or otherwise) or the like. Alternatively, the heater may be integrated into or attached to various components of transportation vehicles such as seats, benches, mirrors or mirror assemblies (e.g. rearview mirrors, side view mirrors or the like), gear shifters, panels, footwells, floor mats, cargo or bed liners, windows, batteries, or other components. The heater of the present teachings may be located anywhere throughout a vehicle, and most advantageously, with components that generally come in contact with an occupant of the vehicle including arm rests, rear view mirrors, user control interfaces, seats, steering wheels, or otherwise. The heater may be employed for other heating applications external of a vehicle (e.g., bedding, clothing, helmets, shoes, tool handles, growing plants, medical uses, pharmaceutical uses, or otherwise).

The heater is particularly suitable for integration into a seat of an automotive vehicle. More particularly, the heater is suitable for integration with the seat portion with or without bolsters, back portion with or without bolsters, head rest portion, or a combination thereof. The heater may include discrete portions that heat the bolsters of a vehicle seat. Preferably, the heater includes a discrete portion that is suitable to heat the bolsters of a seat. The heater may include a discrete portion that heats a thigh portion of a vehicle seat. The heater may include a discrete portion that moves with a movable thigh portion of the vehicle seat. The jumpers may attach discrete carriers that heat one or more bolsters, one or more thigh regions, a head rest, a seat and a back, or a combination thereof. The jumpers may extend between and through one or more of the regions discussed herein, a trench, a bite line, or a combination thereof so that the discrete heater portions are electrically connected and produce heat.

The heater may be located under a fabric layer (e.g. cloth, leather, synthetic leather, or the like) and on top of a cushion, backrest, bolster, thigh support, or a combination thereof (e.g. a foam support for the user). In one aspect, the present teaching employs a structure that makes it particularly suited for use beneath a perforated leather seat cover or perforated synthetic leather seat cover. In this manner, the present heaters are particularly attractive for use in combination with a conditioned seat (e.g. a ventilated, actively cooled and/or actively heated (such as by use of a thermoelectric device or module)).

The seat of the vehicle may include one or more fans or blowers that move air for passenger comfort. For example, the blower may pull air away from the user, or the blower may push air towards the user. The blower and/or fan may include its own conditioning device such as a thermoelectric device or a Pelletier device. The conditioning device may be used to provide heat. The conditioning device may be used to provide cool air. The heater as discussed herein may be used to provide heated air. The fan and/or blower may move air towards the occupant and the heater may heat the air as the air exits the through holes of the heater. Preferably, the proximity of the through holes of the heater is heated so that the through holes are not a cold spot as air travels out of the through holes during a heating application. For example, as air passes through the through holes heat around the through holes will be removed, and if the through holes are entirely surrounded by only one conductive electrically functional layer then the through hole temperature cannot be maintained by the resistive material. However, in the configuration taught herein the resistive material borders the through holes and provides heat to the region directly adjacent to the through holes so that the temperature difference between the area adjacent the through hole and an area of the heater that does not include a through hole are substantially similar. The region directly adjacent the through holes, preferably heats the fluid as it passes through the through holes. The difference in temperature between an area directly adjacent a through hole and an area that does not include a through hole will be substantially equal (i.e. about 1° C. to about 5° C.) when no air is passed through the through hole. The difference in temperature between an area directly adjacent a through hole that is heated and an area that does not include a through hole will be about 8° C. or less, about 5° C. or less, about 3° C. or less, about 2° C. or less, and or about 1° C. or less when a fluid is passed through the through hole. The difference in temperature between an area directly adjacent a through hole that is not heated and an area that does not include a through hole will be about 1° C. or more, about 2° C. or more, about 3° C. or more, or even but 5° C. or more when a fluid is passed through the through hole.

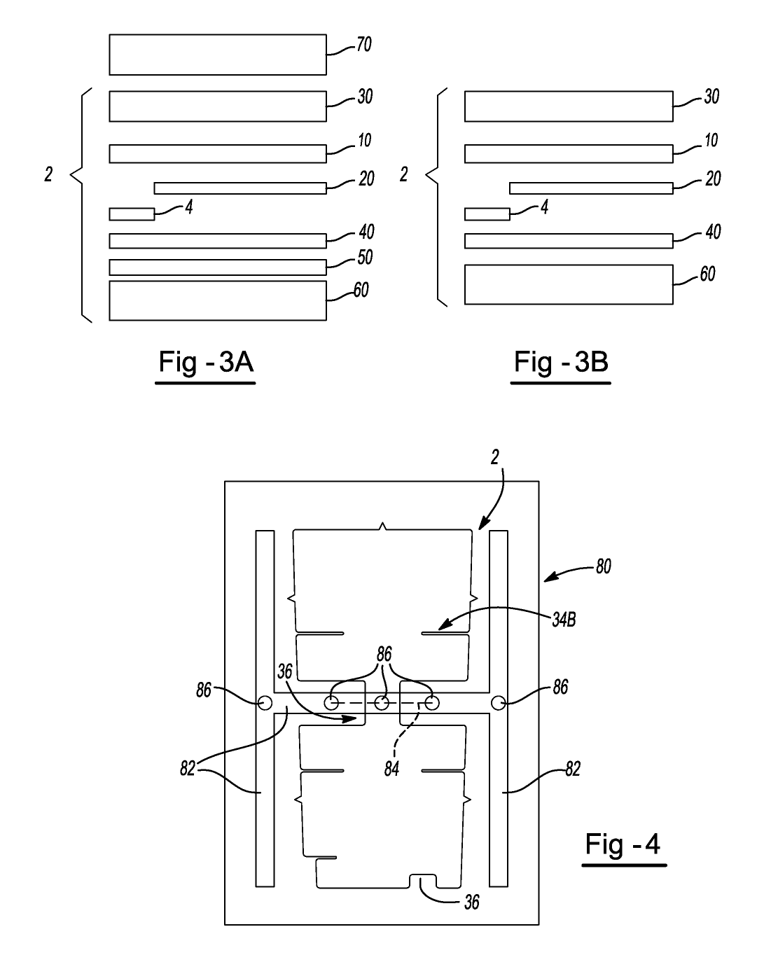

The vehicle seat may include a cushion and the cushion may include one or more trench areas and one or more bolsters. Preferably, the heater can be used with any trench discussed herein. Additional aspects of trenches can be gleaned from the teachings herein including those of paragraphs 0089, 0098, 0112, and 0118 and FIG. 3 of U.S. patent application Ser. No. 13/106,140 filed on May 12, 2011, the teachings of which are incorporated by reference herein. The cushion and/or occupant sensor mat may include one or more through holes. The one or more through holes may substantially align with the through holes in the heater. The seat trim layer may include one or more through holes that substantially align with the through holes in the heater. The trim layer may include a plurality of through holes that align with each through holes of the heater. Preferably, the through holes in the cushion, the heater, and the trim layer substantially align so that a fluid (e.g. air) can pass through the through holes toward and/or away from the passenger and/or occupant of the vehicle. If the heater includes a third layer, a fourth layer, a fifth layer, or a combination thereof then each corresponding layer may include one or more through hole that substantially align with the one or more through hole in the carrier and/or that may be permeable so that fluids (i.e., air) may pass though the through holes.

It is further contemplated that the vehicle seat may include an occupant sensor. Additional aspects of the occupant sensor can be gleaned from the teachings herein including those of paragraphs 099 and 126 of U.S. patent application Ser. No. 13/106,140 filed on May 12, 2011, the teachings of which are incorporated by reference herein. Additional occupant sensors that may be used with the teachings herein includes those of U.S. Pat. Nos. 5,986,221; 6,494,284; 6,906,293; 7,202444; 7,306,283; 7,500,536; and 7,708,101; U.S. Patent Application. Publication Nos. 2002/000742; 2006/162983; 2007/0215601; and 2007/0290532; and European Patent No, EP1209026 incorporated by reference herein.

The heaters as discussed herein may be created using a method as described herein. Specifically, the method may be used to heat the region surrounding a through hole, create a heater having multiple discrete carriers, and/or a heater having an improved current density. These methods comprise one or more of the following steps. Obtaining a carrier that includes a through hole. Obtaining a carrier and then creating through holes in the carrier. Applying a first electrically conductive layer around at least a portion of a through hole so that a portion of the region directly adjacent the though hole is free of the first electrically functional layer. Applying the first electrically functional layer so that the first electrically functional layer has a portion with a first polarity and a portion with a second polarity. Applying a second electrically functional layer between the first electrically functional layer and the through hole. Applying the second electrically functional layer in the region directly adjacent the through hole. Applying the second electrically functional layer so that the second electrically functional layer connects the electrically functional layer with a first polarity and the electrically functional layer with a second polarity. Connecting an electrical conductors to the conductive electrically functional layers. Attaching a jumper to one or more discrete carriers. Ultrasonically welding the jumper to one or more discrete carriers ad discussed herein. Conductively gluing one or more jumpers to one or more discrete carriers. Applying power to the electrical conductor and/or the heater so that heat is created.

FIG. 1 illustrates a heater 2. The heater includes a first electrically functional layer 10 and a second electrically functional layer 20. The second electrically functional layer 20 as depicted is shown around the holes only for illustration purposes; the second electrically function layer 20 will be throughout the heating areas of the heater. The first electrically functional layer 10 comprises a first polarity electrically functional portion 12, and a second polarity electrically functional layer 14. The first electrically functional layer includes a first buss bar 18A of the first polarity electrically functional portion 12 and a second buss bar 16B of the second polarity electrically functional portion 14. The first polarity electrically functional portion 12 includes fingers 18A and the second polarity electrically functional portion 14 includes fingers 18B. The heater includes a carrier 30 and the carrier includes through holes 32, an internal slit 34A, and cutouts 36.

FIG. 2 illustrates a close-up view of one through hole 32 of the heater 2 illustrated in FIG. 1. The through hole includes a first polarity electrically functional portion 12 bordering the through hole 32 on one side and a second polarity electrically functional portion 14 bordering the through hole 32 on an opposing side of the through hole 32 as the first polarity electrically functional portion 12. A second electrically functional layer 20 borders the through hole and is located on the carrier 30 in a region between the through hole 32 and both the polarity electrically functional layer 12 and the second polarity electrically functional layer 14. The second, electrically functional layer 20 touches the first polarity electrically functional layer 12 and the second polarity electrically functional layer 14 forming an electrical bridge 38 therebetween.

FIGS. 3A and 38 illustrate possible cross-sectional views of the heater 2 as taught herein. The heater includes a carrier 30. The carrier 30 includes a first electrically functional layer 10 and a second electrically functional layer 20. The carrier includes an electrical connectors 4 that provide power to the first electrically functional layer 10 and the second electrically functional layer 20. The heater 2 includes a fifth layer 60 attached to the carrier over the first electrically functional layer 10 and the second electrically functional layer 20 via the third layer 40. FIG. 3A includes a fourth layer 60 inserted between the third layer 40 and the fifth layer 60. FIG. 3A further illustrates a trim layer 70 that extends over the entire heater 2. The heater 2 may be placed over an article of manufacture (not shown).

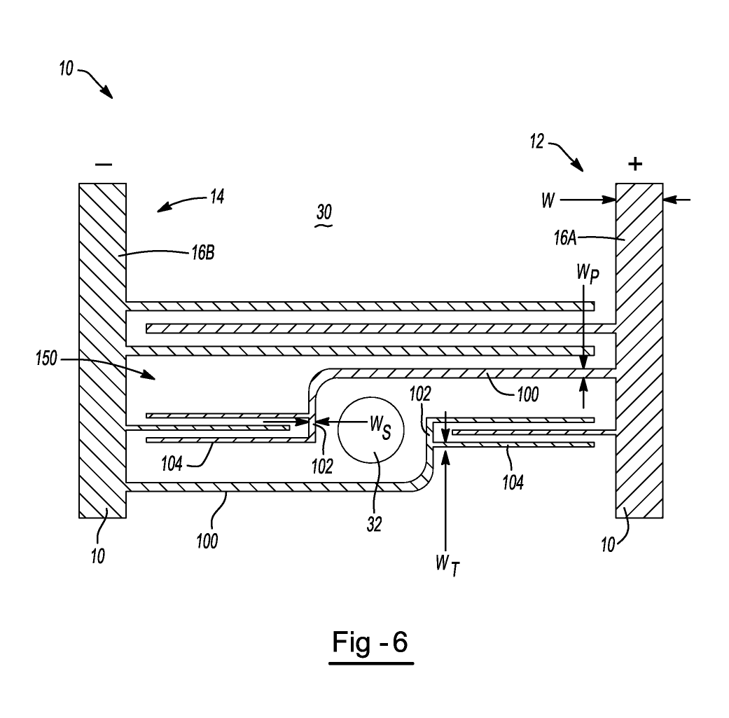

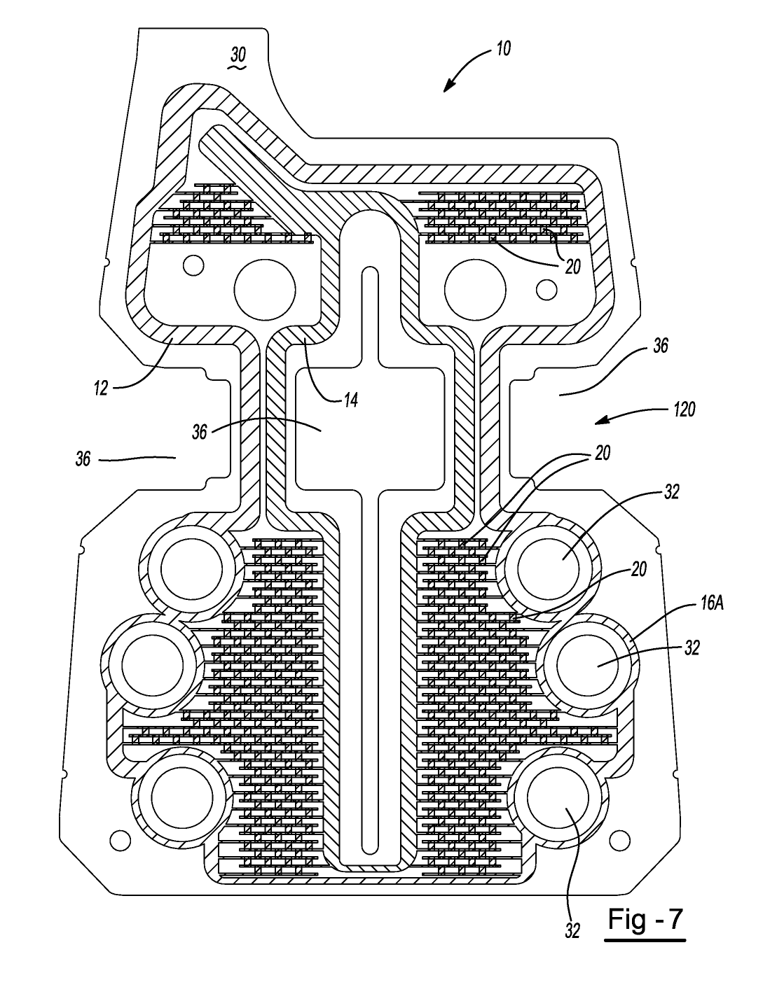

FIG. 4 illustrates the heater 2 (examples of which are shown in FIGS. 1 and 5) placed over an article of manufacture 80. The article of manufacture 80 includes trenches 82. The heater 2 is attached to the article of manufacture 80 using an attachment device 84 that connects with the anchor device 86 located in the trench. The cutouts 36 align with the trench so that a thinner portion between the cutouts 36 is pulled into the trench 82 so that the heater 2 is secured to the article of manufacture 80. The heater 2 further includes an external slit 34B.

FIG. 5 illustrates another close-up view of a through hole 32 as discussed herein. The through hole 32 includes a first electrically functional layer 10 that includes a first polarity electrically functional portion 12 and a second polarity electrically functional portion 14. As illustrated current flows from the first polarity electrically functional portion 12 through a second electrically functional layer 20 (not shown for illustrative purposes so that the paths are clearly illustrated) to the second polarity electrically functional portion 14. The second electrically functional layer 20 produces heat as electricity passes through the second electrically functional layer.

FIG. 6 illustrates one possible configuration of the conductive electrically functional layers 10. The conductive functional layer 10 includes a first polarity electrically functional portion 12 and a second polarity electrically functional portion 14. Both the first polarity electrically functional portion 12 and the second polarity electrically functional portion 14 include a main electrically functional portion 16A and 168 respectively. The first polarity electrically factional portion 12 and the second polarity electrically function portion further include a primary path 100, a secondary path 102, and tertiary path 104 extending therefrom. The primary path 100, the secondary path 102, and the tertiary path 104 extending within a heating region 150; the heating region as illustrated does not include the second electrically functional layer 20 for illustrative purposes only. As illustrated, the first buss bar 16A and the second buss bar 16B have a width (W), the primary path has a width (W_{P}), the secondary path has a width (W_{S}), and the tertiary path has a width (W_{T}). The first electrically functional portion and the second electrically functional portion are located adjacent to a through hole 32 in the carrier 30, and the first polarity electrically functional portion 12 opposes the second polarity electrically functional portion 14. FIG. 6 is illustrated without a second electrically functional layer 20 for illustrative purposes only.

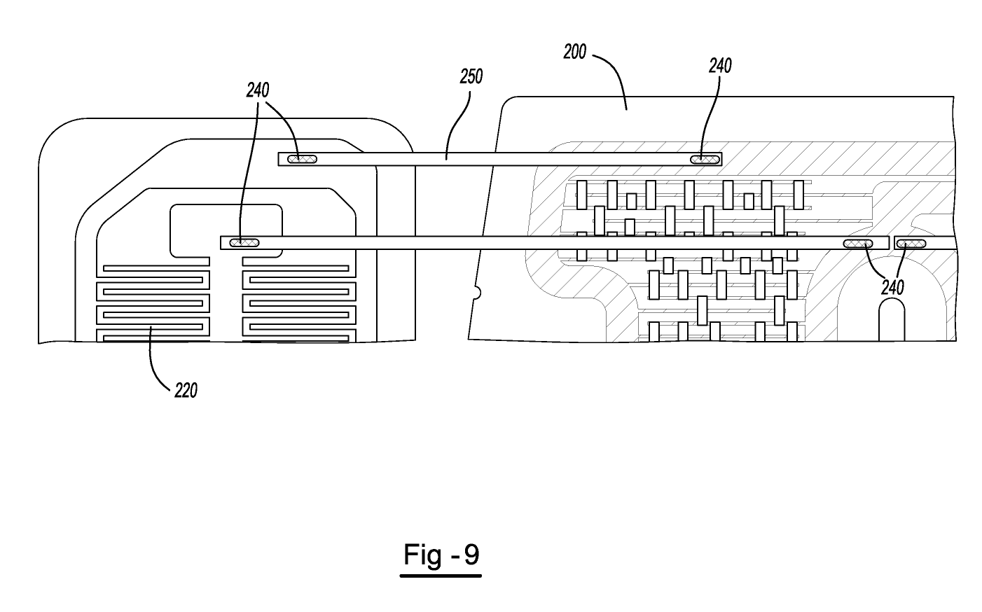

FIG. 7 illustrates another possible configuration of a heater as taught herein. The heater include a carrier 30 with a plurality of through holes 32 extending there through. The through holes are surrounding by a first electrically functional layer 10. As illustrated, a first bus bar 16A splits and extends around each through hole 32 so that the through hole is substantially surrounded by a single bus bar 16A. The carrier 30 further includes an internal cutout 36 with external cutouts 36 on both sides forming a neck region 120 in the carrier 30. The first electrically function layer 10 includes a first polarity electrically function portion 12 and a second polarity electrically function portion 14 of opposite polarity. The first polarity electrically function portion 12 and the second polarity electrically function portions 14 are connected via a second polarity electrically functional portion 20.

FIG. 8 illustrates a heater 2 comprising multiple carriers 30. The heater includes a discrete main carrier 200, two discrete secondary carriers 220, and jumpers 250 connecting the discrete secondary carriers 220 electrically to the discrete main carrier 200. The discrete secondary carriers 220 as illustrated herein heat bolster portions of a vehicle seat (not shown). The second electrically functional layer 20 is not illustrated on the two discrete secondary carriers 220 for illustrative purposes so that the jumpers 250 and their connection regions are clearly depicted.

FIG. 9 illustrates a close-up view of the connection regions 240 of the jumpers 250 to the discrete main carrier 200 and the discrete secondary carrier 220.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. The are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or approximately in connection with a range applies to both ends of the range, Thus, “about 20 to 30” is intended to cover “about 20 to about 30”, inclusive of at least the specified endpoints.

The disclosures of all art and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

We claim:

1. A heater comprising:
a. at least one carrier comprising:
1. a first electrically functional layer disposed on the carrier;
2. a second electrically functional layer disposed on the carrier and in contact with the first electrically functional layer; and
3. one or more electrical conductors connected to the first electrically functional layers for applying power to the heater;
wherein the heater includes one or more of the following features:
1) one or more through holes in the carrier, wherein the first electrically function layer includes a portion having a first polarity and a portion having a second polarity that each border an opposing region of at least one of the one or more through holes, and the second electrically functional layer being disposed so that the second electrically functional layer electrically connects the portion having the first polarity and the portion having the second polarity between the opposing regions so that a region around the at least one of the one or more through holes is heated;
2) one or more heating regions, wherein the first electrically functional layer is a conductive material, and wherein the one or more heating regions are defined between two main electrically functions paths the main electrically functions paths each include:
a) at a primary conductive path having a first width; and
b) a secondary conductive path adjoining the primary conductive path, the secondary conductive path having a second width that is reduced relative to the primary conductive path so that the width of the secondary conductive path is approximately proportional to current carrying requirements for the one or more heating regions;
3) wherein the at least one carrier is a plurality of discrete carriers and only one of the plurality of discrete carriers is connected to the one or more electrical conductors, and each discrete carrier includes: the first electrically functional layer, and the second electrically functional layer, and wherein each of the plurality of discrete heaters are electrically connected so that when power is applied each of the discrete carriers produce heat; and
4) one or more through holes in the carrier, wherein the first electrically functional layer has a buss portion having a first polarity and a buss portion having a second polarity, wherein the buss portion having the first polarity, the buss portion having the second polarity, or both split so that one of the buss portion having the first polarity or the buss portion having the second polarity extends simultaneously around at least one of the one or more through holes so that the at least one of the one or more through holes is substantially surrounded by the buss portion having the first polarity, the buss portion having the second polarity, or both.

2. The heater of claim 1, wherein carrier includes at least two through holes, and the portion having a first polarity borders about 30 percent of the one or more through holes or more and the portion having a second polarity borders about 30 percent of the one or more through holes or more, and the second electrically functional layer extends between the portion having the first polarity and the portion having the second polarity so that the region around the through hole is heated.

3. The heater of claim 1, wherein the first electrically functional layer borders less than about 99 percent of the one or more through holes.

4. The heater of claim 1, wherein the heating region further includes a tertiary conductive path having a width that is reduced relative to both the primary conductive path and the secondary conductive path so that the width of the tertiary conductive path is approximately proportional to current carrying requirements for the one or more heating regions.

5. The heater of claim 4, wherein the width of the primary conductive path is X, the width of the secondary conductive path is between about 1.0X to about 0.8X, and the width of the tertiary conductive path is between about 0.65X to about 0.45X.

6. The heater any claim 4, wherein the width of the primary conductive path is between about 3.0 mm and about 2 mm, the width of the secondary conductive path is between about 2.5 mm and about 0.8 mm, and the width of the tertiary conductive path is between about 1.2 mm and about 0.6 mm.

7. The heater any claim 5, wherein the width of the primary conductive path is between about 3.0 mm and about 1.2 mm, the width of the secondary conductive path is between about 2.5 mm and about 0.8 mm, and the width of the tertiary conductive path is between about 1.2 mm and about 0.6 mm.

8. The heater of claim 1, wherein the heater comprises two or more discrete carriers, wherein one discrete carrier is a discrete main carrier that heats a main portion of a vehicle seat and one or more discrete carrier is a more discrete secondary carrier that heats one or more bolster portions, one or more thigh regions, or both of the vehicle seat.

9. The heater of claim 8, wherein the main discrete carrier is electrically connected to the one or more discrete secondary carriers by at least one jumper that is made of the same material as the two or more discrete carriers, and
wherein the jumper includes the first electrically functional layer disposed on at least one side.

10. The heater of claim 9, wherein the at least one jumper is free of mechanical attachment to attach the main discrete carrier and the one or more discrete secondary carriers.

11. The heater of claim 9, wherein the at least one jumper is attached to the main discrete carrier and the one or more discrete secondary carriers using ultrasonic welding, a conductive adhesive, or both.

12. The heater of claim 10, wherein the at least one jumper is attached to the main discrete carrier and the one or more discrete secondary carriers using ultrasonic welding, a conductive adhesive, or both.

13. The heater of claim 1, wherein the buss portion having a first polarity, the buss portion having a second polarity, or both have a width before the split, and wherein a aggregate width of the split in the buss portion having the first polarity, the buss portion having the second polarity, or both is equal to or less than the width before the split so that current carrying capacity of the aggregate width around the one or more through holes of the buss portion having the first polarity, the buss portion having the second polarity, or both are substantially equal to current carrying capacity before the split.

14. The heater of claim 12, wherein the buss portion having a first polarity, the buss portion having a second polarity, or both have a width before the split, and wherein a aggregate width of the split in the buss portion having the first polarity, the buss portion having the second polarity, or both is equal to or less than the width before the split so that current carrying capacity of the aggregate width around the one or more through holes of the buss portion having the first polarity, the buss portion having the second polarity, or both are substantially equal to current carrying capacity before the split.

15. A vehicle seat comprising:
a. a cushion having one or more through holes;
b. a trim layer having one or more through holes; and
c. the heater of claim 1 located between the cushion and the trim layer; wherein the one or more through holes in the cushion correspond to the one or more through holes in the heater and the trim layer so that a fluid can be moved through the cushion, trim layer and the heater towards and/or away from an occupant.

16. The vehicle seat of claim 15, wherein the vehicle seat includes one or more air movers that move air towards an occupant, and the region around the one or more through holes in the carrier is heated while the fluid is being moved through the one or more through holes in the cushion so that the fluid is heated as the fluid travels towards the occupant.

17. The vehicle seat of claim 15, wherein the at least one carrier is attached to a third layer that covers the first electrically functional layer and the second electrically functional layer, and the third layer either includes one or more through holes that correspond to the one or more through holes of the carrier or the third layer is breathable so that the fluid passes through the third layer.

18. The vehicle seat of claim 16, wherein the at least one carrier is attached to a third layer that covers the first electrically functional layer and the second electrically functional layer, and the third layer either includes one or more through holes that correspond to the one or more through holes of the carrier or the third layer is breathable so that the fluid passes through the third layer.

19. The vehicle seat of any one of claims 15, wherein the seat includes an occupant sensor located adjacent to the heater.

20. The vehicle seat of any one of claims 18, wherein the seat includes an occupant sensor located adjacent to the heater.
